(19) United States
(12) Patent Application Publication
(10) Pub. No.: US 2005/0180438 A1
(43) Pub. Date: Aug. 18, 2005

(54) Setting timers of a router

(76) Inventors: Eun-Sook Ko, Suwon-si (KR); Byung-Gu Choe, Seoul (KR); Yong-Seok Park, Yongin-si (KR)

Correspondence Address: Robert E. Bushnell;Suite 300, 1522 K Street, N.W., Washington, DC, 20005-1202, US

(21) Appl. No.: 11/011,951

(22) Filed: Dec. 15, 2004

(30) Foreign Application Priority Data
Jan. 30, 2004 (KR) 2004-6306

(51) Int. Cl. H04L 12/28

(52) U.S. Cl. 370/401

(57) ABSTRACT

A method and apparatus and a program storage device, readable by a machine, tangibly embodying a program of instructions executable by the machine performs a method including: receiving an update message at a router, the update message including a timer value from at least one other router according to a routing protocol; extracting the timer value from the update message received from the at least one other router; and resetting the timer value in response to a difference between the extracted timer value of the at least one other router and the set timer value.

### CLAIM OF PRIORITY

This application makes reference to, incorporates the same herein, and claims all benefits accruing under 35 U.S.C. §119 from an application for METHOD AND APPARATUS FOR SETTING TIMERS OF ROUTER earlier filed in the Korean Intellectual Property Office on 30 Jan. 2004, and there duly assigned Serial No. 2004-6306.

### BACKGROUND OF THE INVENTION

1. Field of the Invention

The present invention relates to setting timers of a router and, more particularly, to setting timers of a router, in which the router operating according to a Routing Information Protocol (RIP) or a Routing Information Protocol Next Generation for IPv6 (RIPng) sets a timeout timer value in response to an update timer value which is set for at least one other router, to prevent flapping and to rapidly cope with network changes.

2. Description of the Related Art

Currently, both RIP used in network routers according to IPv4 and RIPng used in network routers according to IPv6 have three timers as follows.

The first timer is an update timer, in which each router transmits messages to its neighboring routers in a given period of time on a basis of a broadcast mode. In other words, each router transmits an update message to all of the routers included in a routing table according to RIP/RIPng.

The update timer has a basic recommendation value of 30 seconds. When there are several routers within the same network, each router simultaneously exchanges messages every 30 seconds.

Also, when each router transmits the update message in accordance with the update timer, there is a possibility of a collision between the exchanged messages. For this reason, it is recommended that each router use a random time as an offset value (recommended value is ±0-5 seconds).

That is, when a basic time value of the update timer is set to 30 seconds in order to transmit the update message, each router transmits the update message by taking any one time value between 25 and 35 seconds, which are calculated by adding 30 seconds of the basic time value to ±0-5 seconds of the random offset value.

The second timer is a timeout timer, which makes it possible for each router to determine which one of the neighboring routers connected via the network is not valid.

However, although each router determines if any one of the neighboring routers is not valid, that is, dropped, each router stores routing information of the dropped neighboring router in its own routing table in order to inform other neighboring routers that the neighboring router has been dropped.

Therefore, when a router determines that the neighboring router is not valid, the router again determines whether or not the message has been transmitted from the dropped router for a predetermined time.

This timeout timer is initialized whenever a new router is formed and whenever the update message has been received from the router determined to be invalid. The timeout timer has a recommended value of 180 seconds.

That is, when no update message has been transmitted from the neighboring router for the predetermined time, the router determines that the neighboring router is not valid and again determines whether or not the update message has been transmitted for a given time.

The third timer is a garbage collection timer, in which, when no update message has been transmitted from the neighboring routers while the timeout timer has timed out, i.e., when the timeout timer for the neighboring routers expires or when a metric (a value allocated to a route) is updated to 16, the router determines that the neighboring routers are not valid.

However, while timing out the garbage collection timer set to transmit the routing information on the dropped router which has been determined to be invalid, to the other routers connected through the network, the router informs the other routers that the neighboring router is invalid or dropped while keeping the routing information of the neighboring router in a routing table.

When the garbage collection timer expires, the router deletes the routing information on the corresponding router from the routing table.

In this case, the garbage collection timer has a recommended value of 120 seconds. The garbage collection timer is initialized if a new router is added.

An administrator of a router using RIP/RIPng can properly set values of the update timer, the timeout timer, and the garbage collection timer according to state of the network.

The following patents each discloses features in common with the present invention but do not teach or suggest the inventive features specifically recited in the present application: U.S. Patent Application No. 2002/0078223 to Baldonado et al., entitled METHOD AND APPARATUS FOR PERFORMANCE AND COST OPTIMIZATION IN AN INTERNETWORK, published on Jun. 20, 2002; U.S. Patent Application No. 2002/0004843 to Andersson et al., entitled SYSTEM, DEVICE, AND METHOD FOR BYPASSING NETWORK CHANGES IN A ROUTED COMMUNICATION NETWORK, published on Jan. 10, 2002; U.S. Patent Application No. 2002/0169887 to McLampy et al., entitled SYSTEM AND METHOD FOR ASSISTING IN CONTROLLING REAL-TIME TRANSPORT PROTOCOL FLOW THROUGH MULTIPLE NETWORKS VIA SCREENING, published on Nov. 14, 2002; U.S. Patent Application No. 2002/0145975 to McLampy et al., entitled SYSTEM AND METHOD FOR ASSISTING IN CONTROLLING REAL-TIME TRANSPORT PROTOCOL FLOW THROUGH MULTIPLE NETWORKS VIA USE OF CLUSTER OF SESSION ROUTERS, issued on Oct. 10, 2002; U.S. Patent Application No. 2002/0114282 to McLampy et al., entitled SYSTEM AND METHOD FOR ASSISTING IN CONTROLLING REAL-TIME TRANSPORT PROTOCOL FLOW THROUGH MULTIPLE NETWORKS, published on Aug. 22, 2002; U.S. Patent Application No. 2002/0112073 to McLampy et al., entitled SYSTEM AND METHOD FOR ASSISTING IN CONTROLLING REAL-TIME TRANSPORT PROTOCOL FLOW THROUGH MULTIPLE NETWORKS VIA MEDIA FLOWROUTING, published on Aug. 15, 2002; and U.S. Patent Application No. 2002/0093954 to Weil et al., entitled FAILURE PROTECTION IN A COMMUNICATIONS NETWORK, published on Jul. 18, 2002.

### SUMMARY OF THE INVENTION

Accordingly, the present invention is made to solve the above-mentioned problems, and an objective of the present invention is to provide a method and apparatus and a program storage device, readable by a machine, tangibly embodying a program of instructions executable by the machine to perform a method for setting a timer in router, capable of allowing each router to set a proper timeout timer value according to update timer value set for the other router, preventing flapping, and rapidly dealing with network changes.

In order to accomplish these objectives, the present invention provides a router comprising: a message extracting unit adapted to extract a timer value from an update message including the timer value transmitted from at least one other router over a network according to a routing protocol; and a timer setting unit adapted to reset the timer value in response to a difference between the timer value extracted from the message extracting unit and a timer value preset in the router.

The timer value comprises at least one of an update timer value, a timeout timer value, and a garbage collection timer value.

The routing protocol comprises at least one of a Routing Information Protocol (RIP), and a Routing Information Protocol next Generation for Ipv6 (RIPng).

The update message comprises at least one of information on the timer value set for the router and information indicating the timer value.

The router further comprises a message generating unit adapted to generate the update message using the set timer value and a random offset value based on a set routing protocol.

The timer setting unit is adapted to reset the timer value of the router to a comparison value adding a maximum offset value to the timer value of another router, upon the comparison value being greater than the preset timer value.

The timer setting unit is adapted to reset the timer value of the router to a comparison value adding a maximum offset value to the timer value of another router, upon the comparison value being greater than the preset timer value.

The timer setting unit is adapted to reset the timer value of the router to a comparison value adding the timer value transmitted from another router to a random offset value when the router is initially driven, upon the comparison value being smaller than the preset timer value.

In order to accomplish these objectives, the present invention also provides a router comprising: a message generating unit adapted to generate an update message including an update timer value set according to a routing protocol; a message processing unit adapted to extract the update timer value including the update message transmitted from another router; and a timer setting unit adapted to reset the timeout timer value of the router in response to a difference between the update timer value of the another router extracted from the message processing unit and the timeout timer value set for the router.

The routing protocol is at least one of a Routing Information Protocol (RIP), and a Routing Information Protocol next Generation for Ipv6 (RIPng).

The message generating unit is adapted to generate the update message using the set update timer value and a random offset value according to the set routing protocol.

The timer setting unit is adapted to reset the timer value of the router to a comparison value adding a maximum offset value to the update timer value of the another router provided by the message processing unit, upon the comparison value being greater than the timeout timer value set for the router.

In order to accomplish these objectives, the present invention also provides a method comprising: receiving an update message at a router, the update message including a timer value from at least one other router according to a routing protocol; extracting the timer value from the update message received from the at least one other router; and resetting the timer value in response to a difference between the extracted timer value of the at least one other router and the set timer value.

The update message is generated in response to the set timer value and a random offset value according to the routing protocol.

Resetting the timer value comprises: comparing a comparison value adding a maximum offset value to the extracted timer value of the at least one other router with the timer value set for the router; and resetting the timer value of the router to the comparison value upon the comparison value being greater than the timer value.

The timer value of the router is reset to the comparison value when the router was initially driven upon a comparison value adding the timer value transmitted from the other router to a random offset value being smaller than the preset timer value.

The timer value of the router is reset to the comparison value when the router was connected to one router through a network upon a comparison value adding the timer value transmitted from the at least one other router to a random offset value being smaller than the preset timer value.

The timer value comprises at least one of an update timer value, a timeout timer value, and a garbage collection timer value.

The routing protocol comprises at least one of a Routing Information Protocol (RIP), and a Routing Information Protocol next Generation for Ipv6 (RIPng).

The update message comprises at least one of information of the timer value set for the router and information indicating the timer value.

In order to accomplish these objectives, the present invention also provides a router, comprising: a routing processor adapted to process entry information transmitted from a peer connected through a network according to a preset routing protocol, to determine a best route, and to store routing information of the peer; at least one input/output processor adapted to establish forwarding information of a packet to be transmitted from the peer on the basis of the routing information stored in the routing processor, and to output the packet according to the forwarding information upon the packet being transmitted from the peer; and a switching fabric adapted to switch the packets received through the at least one input/output processor to output the packet to a desired destination.

In order to accomplish these objectives, the present invention also provides a program storage device, readable by a machine, tangibly embodying a program of instructions executable by the machine to perform a method comprising: receiving an update message at a router, the update message including a timer value from at least one other router according to a routing protocol; extracting the timer value from the update message received from the at least one other router; and resetting the timer value in response to a difference between the extracted timer value of the at least one other router and the set timer value.

The update message is generated in response to the set timer value and a random offset value according to the routing protocol.

Resetting the timer value comprises: comparing a comparison value adding a maximum offset value to the extracted timer value of the at least one other router with the timer value set for the router; and resetting the timer value of the router to the comparison value upon the comparison value being greater than the timer value.

The timer value of the router is reset to the comparison value when the router was initially driven upon a comparison value adding the timer value transmitted from the other router to a random offset value being smaller than the preset timer value.

The timer value of the router is reset to the comparison value when the router was connected to one router through a network upon a comparison value adding the timer value transmitted from the at least one other router to a random offset value being smaller than the preset timer value.

The timer value comprises at least one of an update timer value, a timeout timer value, and a garbage collection timer value.

The routing protocol comprises at least one of a Routing Information Protocol (RIP), and a Routing Information Protocol next Generation for Ipv6 (RIPng).

### BRIEF DESCRIPTION OF THE DRAWINGS

A more complete appreciation of the present invention, and many of the attend advantage thereof, will become readily as the same becomes better understand by reference to the following detailed description when considered in conjunction with the accompanying drawings in which like reference symbol indicate or similar components, wherein

FIG. 1 is a block diagram of a network including a router;

FIG. 2 is a table of time values set for a timer of each router;

FIG. 3 is a block diagram of a router according to an embodiment of the present invention;

FIG. 4A is a view of an update message transmitted according to RIP by a router;

FIG. 4B is a view an update message generated by a message generating unit according to an embodiment of the present invention;

FIG. 5A is a view of an update message transmitted according to RIPng by a router;

FIG. 5B is a view of an update message transmitted according to RIPng in accordance with another embodiment of the present invention; and

FIG. 6 is a flowchart of a method of setting a timer with a router according to an embodiment of the present invention.

### DETAILED DESCRIPTION OF THE INVENTION

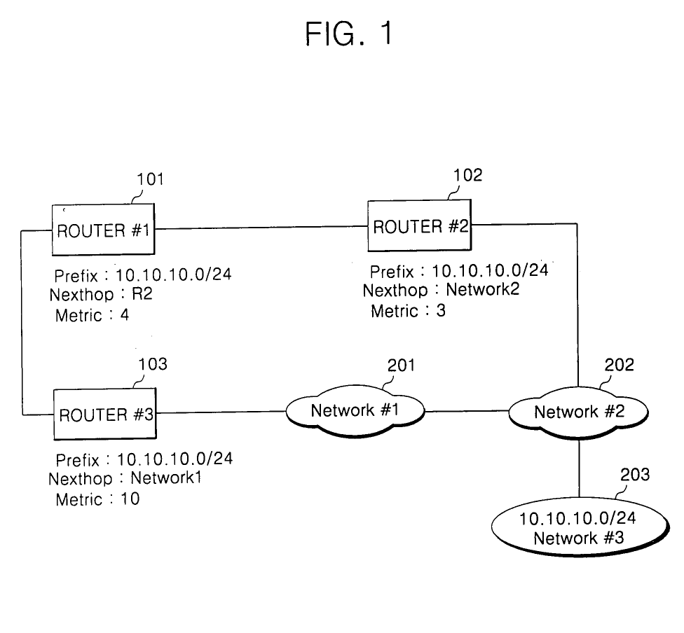

FIG. 1 is a block diagram of a network including routers.

As shown in FIG. 1, a plurality of routers 101, 102 and 103 are connected to a plurality of networks 201, 202 and 203.

Each of the routers 101, 102 and 103 has a routing table, in which router information on the third network 203 having an IP address of 10.10.10.0/24 is stored.

Specifically, with regard to the router information of the third network 203, the router #1 101 stores the information indicating that the next hop is the router #2 and a metric is 4, and the router #2 102 stores the information indicating that the next hop is a second network and the metric is 3.

Further, the router #3 103 stores the information indicating that the next hop is the first network and the metric is 10.

Each of the routers 101, 102 and 103 carries out an update timer, a timeout timer and a garbage collection timer according to RIP/RIPng.

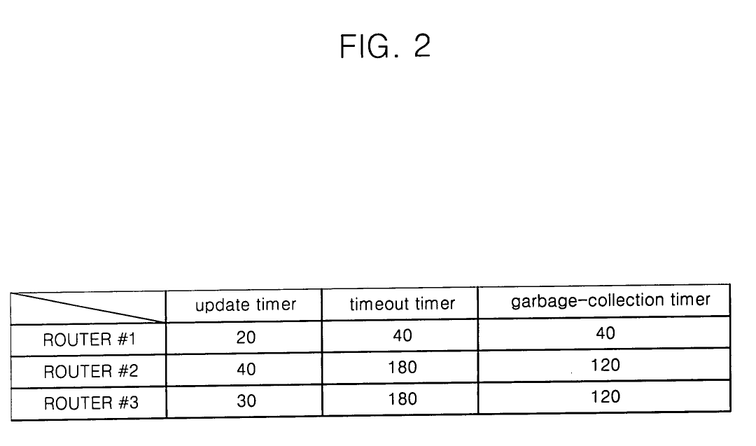

FIG. 2 is a table of time values set for a timer of each router.

As shown in FIG. 2, a network administrator sets values of the update, timeout and garbage collection timers of the router #1 101 to 20, 40 and 40 seconds respectively, sets the values of the update, timeout and garbage collection timers of the router #2 102 to 40, 180 and 120 seconds respectively, and sets the values of the update, timeout and garbage collection timers of the router #3 103 to 30, 180 and 120 seconds, respectively.

Each of the routers 101,102 and 103 generates an update message including the entry information in a period of the set update timer value, and outputs the generated update message to the networks 201, 202 and 203.

Each of the routers 101, 102 and 103 determines that the other non-transmitting routers are not valid if the update message has not been transmitted from other routers 101, 102 and 103 except itself during a set timeout timer value.

In order to delete the routing information of the other non-transmitting routers determined to be invalid from the routing table, each of the routers 101, 102 and 103 drives the garbage collection timer to delete the routing information of the other non-transmitting routers from the routing table when the garbage collection timer has expired.

At this time, each of the routers 101, 102 and 103 informs other routers 101, 102 and 103 except itself that the other non-transmitting routers 101, 102 and 103 are not valid, while keeping the routing information of other non-transmitting routers determined to be invalid in the routing table during a garbage collection timer period.

Each of the routers 101, 102 and 103 generate the update message by reflecting a random offset value during the set update timer value.

That is, the router #1 101 adds ±0-5 seconds of the offset value to 20 seconds of the set update timer value, thereby generating the update message in a period between 15 and 25 seconds. The generated update massage is transmitted to the other routers 102 and 103. And, the router #2 102 adds ±0-5 seconds of the offset value to 40 seconds of the set update timer value, thereby generating the update message in a period of 35 to 45 seconds. The generated update message is transmitted to the other routers 101 and 103.

Also, the router #3 103 adds ±0-5 seconds of the offset value to 30 seconds of the set update timer value, thereby generating the update message in a period of 25 to 35 seconds. The generated update message is transmitted to the other routers 101 and 102.

However, when each of the routers 101, 102 and 103 deals with a routing protocol according to RIP or RIPng, the values set for the timers can cause a flapping phenomenon such that next hop information is changed.

For example, when the values set for each timer in the routers 101, 102 and 103 are as shown in FIG. 2, the router #2 102 transmits the update message to the router #1 101 in the period of 35 to 45 seconds based on a relationship between 40 seconds or the set update timer value, and ±0-5 seconds or the random offset value.

When the router #2 102 selects the update timer value to be 45 seconds and then transmits the update message, the router #1 101 cannot receive the update message transmitted from the router #2 102 for 20 seconds of the timeout timer value, thereby determining that the router #2 102 is not valid.

Therefore, because the update message is not transmitted from the router #2 102 until the timeout timer has expired, the router #1 101 elects the router #3 103 to be the next hop based on a best route for the third network.

That is, if the set timeout timer value is smaller than the update timer value of the router #2 102, the router #1 101 incorrectly determines the router #2 102 to be invalid, and elects the next hop to be the router #3 103, even though the next hop based on the actual best route is the router #2 102. Accordingly, the router #1 101 stores the information indicating that the next hop is the router #2 and the metric is 11 in the routing table.

Meanwhile, the router #2 102 transmits a former update message based on 45 seconds of the selected update timer value and transmits another update message after 45 seconds have elapsed, so the router #1 101 receives the update message from the router #2 102 within about 5 seconds after timeout timer has expired.

Therefore, because the update message is transmitted from the router #2 102, the router #1 101 changes the next hop information, i.e., the routing information on the third network 203, from the router #3 to the router #2 and rewrites the metric information to be 4.

As a result, the router #1 101 changes both the next hop information as the routing information on the third network 203 and the metric information in a short time.

Thus, the routers 101, 102 and 103 change the routing information stored in the routing table for a short time, which is referred to as the “flapping phenomenon.” This flapping phenomenon increases system loads of the routers 101, 102 and 103, thereby causing a problem in that the system efficiency of the overall networks is decreased.

Also, the router #3 103 transmits the update message including entry information to the router #1 101 in the period of 25 to 35 seconds based on the relationship between ±0-5 seconds of the offset value to 30 seconds of the set update timer value.

Furthermore, the router #1 101 receives the update message transmitted from the router #3 103 within 40 seconds of the set timeout timer value, but the router #1 101 cannot quickly cope with either a drop of the router #3 103 or changes of the networks.

That is, the router #1 101 determines whether or not the update message has been transmitted from the router #3 103 within 40 seconds of the set timeout timer value or not. If the update message has been transmitted, the router #1 101 initializes the timeout timer.

The router #3 103 transmits the update message in a maximum period of 35 seconds based on the relationship between the set update timer value and the offset value.

Therefore, the router #1 101 receives the update message from the router #3 103 within at least 35 seconds. Hence, if the update message has not been transmitted within 35 seconds, the router #1 101 preferably drives the garbage collection timer to delete the routing information of the router #3 103 from the routing table, thereby determining one route based on another best route.

However, because the router #1 101 should determine whether or not the update message has been transmitted from the router #3 103 within 40 seconds of the set timeout timer value, the router #1 101 fails to determine another route, thus maintaining a standby state for about 5 seconds.

Therefore, a problem occurs in that the router #1 101 has a reduced capability to cope with changes of the networks, because of the difference between the set timeout timer value and the update timer value of the router #3 103.

An exemplaery embodiment of the present invention will be described herein below with reference to the accompanying drawings. In the following description, well-know functions or constructions have not been described in detail since they would obscure the present invention in unnecessary detail.

Referring to the drawings, it will be explained that a router #1 101 sets a timeout timer value in accordance with a timer value set for routers 102 and 103. However, the the present invention is not limited thereto.

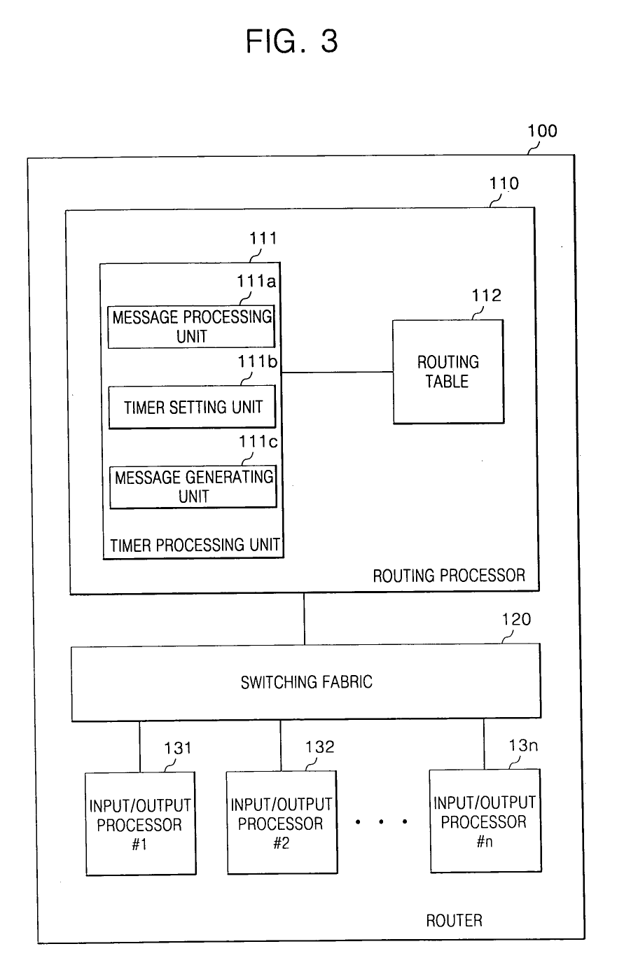

FIG. 3 is a block diagram of a router according to an embodiment of the present invention.

Referring to FIG. 3, a first router 100 according to an embodiment of the present invention includes a plurality of input/output processors 131 to 13n, a switching fabric 120 and a routing processor 110, wherein the routing processor 110 includes a timer processing unit 111 and a routing table 112.

The timer processing unit 111 includes a message processing unit 111a, a timer setting unit 111b, and a message generating unit 111c.

The input/output processors 131 to 13n are connected to a second router 100 through a network (not shown) so as to receive at least one update message and a packet.

The input/output processors establish a forwarding table (not shown) based on routing information stored in the routing table 112 managed by the routing processor 110, forward the packet transmitted from the second router 100 or the network, and output the packet to the corresponding output port.

The switching fabric 120 switches the update messages received through the input/output processors 131 to 13n to the routing processor 110, and enables the input/output processors 131 to 13n to output the received packet to the corresponding output port.

The routing processor 110 determines a best route according to a routing protocol, and manages the routing information according to the best route with the routing table 112.

The routing table 112 stores destination address information, next hop information, metric information, etc, so as to transmit the packet to a destination according to the best route.

A routing protocol processed by the routing processor 110 can be a Routing Information Protocol (RIP), a Routing Information Protocol Next Generation for IPv6 (RIPng), and so on.

The routing processor 110 generates the update message including entry information by using both a random offset value and an update timer value which is set according to the routing protocol.

The routing processor 110 sets the update timer value for the generated update message and transmits it to the second router.

In addition, the routing processor 110 extracts the update timer value from the update message transmitted from the second router and resets a timeout timer value according to the update timer value of the second router.

Furthermore, the timer processing unit 111 of the routing processor 110 generates an update message according to both the set update timer value and the offset value, and transmits the generated update message to the second router.

At this time, the timer processing unit 111 sets the set update timer value for the update message.

The timer processing unit 111 extracts the update timer value from the update message transmitted from the second router, and resets the set timeout timer value based on the extracted update timer value.

The message generating unit 111c of the timer processing unit 111 generates the update message according to the random offset value and the update timer value set by an administrator of the first router 100, and transmits the generated update massage to the second router connected to the network.

At this time, the message generating unit 111c adds the set update timer value to the update message and transmits the result to the second router.

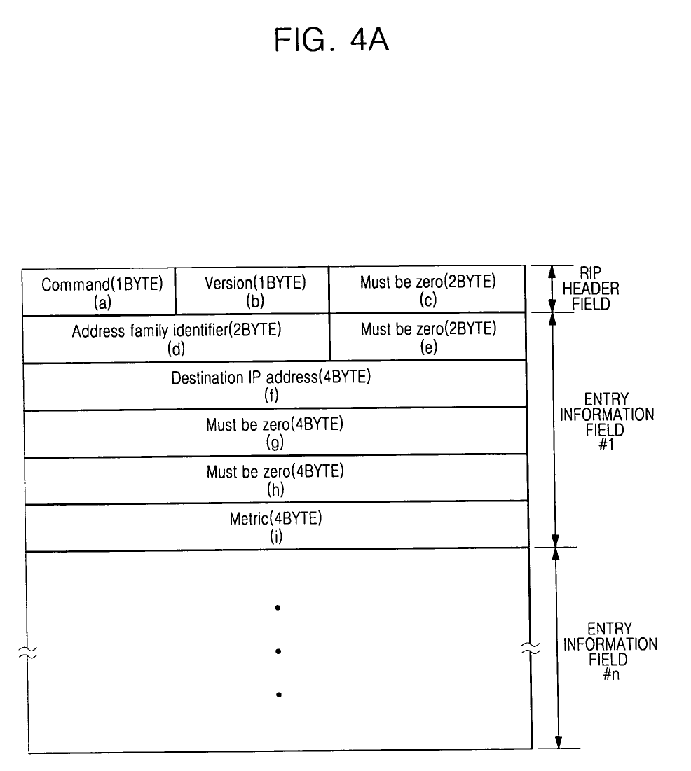

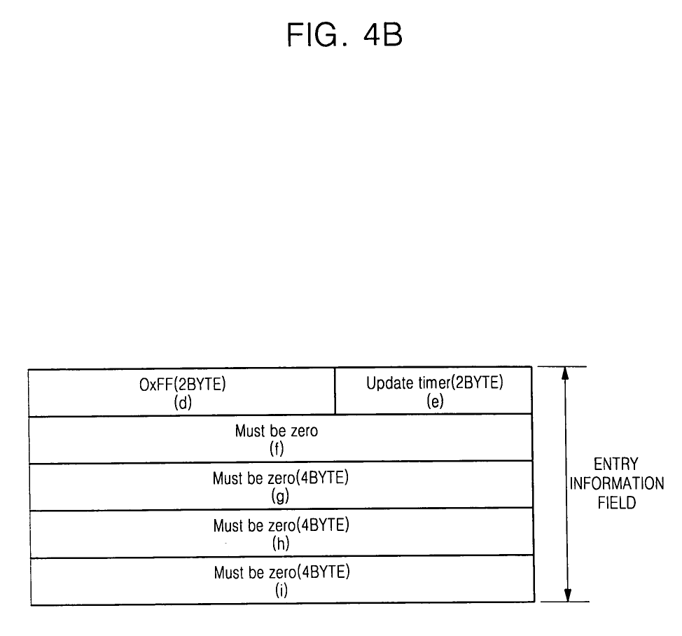

FIG. 4A is a view of an update message transmitted by a router according to RIP.

As shown in FIG. 4A, an update message transmitted by a router using RIP as a routing protocol includes an RIP header field and a plurality of entry information fields. The RIP header field includes a command field (a) for sorting out kinds of packet of the update message, a version field (b) having version information, and a reserved field (Must be zero) (c).

Also, each entry information field includes an AFI field (d) for indicating an Address Family Identifier (AFI), a destination IP address field (f) for indicating a destination IP address, a metric field (i) for indicating metric information, and a plurality of reserved fields (c), (e), (g) and (h).

If the set routing protocol is RIP, the message generating unit 111c of the routing processor 110 sets an update timer value for the update message according to the offset value and the set update timer value, as shown in FIG. 4.

FIG. 4B is a view of an update message generated by a message generating unit according to an embodiment of the present invention.

As shown in FIG. 4B, the message generating unit 111c selects one of a plurality of entry information fields having the update message, and adds the update timer value to the selected entry information field, thereby generating the update message.

That is, information indicating the update timer value can be set for the AFI field (d), and the update timer value can be set for the next field (e).

According to one example, the message processing unit 111a sets 0xFF′ value for the AFI field (d), informs that an update timer value is to be transmitted, and sets an update timer value, which is set by an administrator, for the reserved field (e).

Also, the message processing unit 111a of the router 100 using RIP determines whether or not the update timer value has been included in the update message transmitted from the second router through the network.

That is, the message processing unit 111a determines if the 0xFF′ is set for the AFI field (d) of the update message transmitted from the second router. If the 0xFF′ is set, the message processing unit 111a extracts the update timer value set for the next field and provides the extracted update timer value to the timer setting unit 111b.

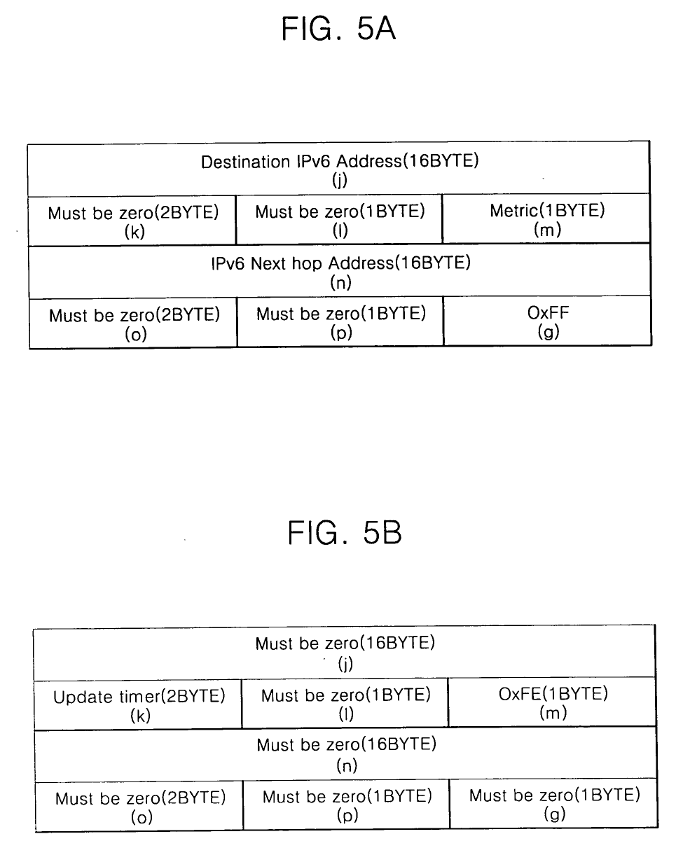

FIG. 5A is a view of an update message transmitted by a router according to RIPng.

As shown in FIG. 5A, an update message transmitted by the router 100, which has IPv6 as an IP address system of its own network and RIPng as a set routing protocol, includes a destination IP address field (j) for indicating the destination IP address, a metric field (m) for indicating the metric information, a next hop address field (n) for indicating the next hop address information, and a plurality of reserved fields (Must be zero) (k), (l), (o) and (p).

The message generating unit 111c of the router 100 which uses RIPng as its routing protocol sets the update timer value for the update message as shown in FIG. 5A, thereby generating the update message.

FIG. 5B is a view of an update message transmitted according to RIPng in accordance with another embodiment of the present invention.

As shown in FIG. 5B, the message generating unit 111c of the router using RIPng generates the update message according to the random offset value and the set update timer value, sets the update timer value for the reserved field (k), and sets information indicating that the update timer value has been set for the metric field (m).

According to the embodiment, “0xFE” informing that the update timer value is set for the metric field (m) is set, and the update timer value is set for the reserved field (k).

Also, the message processing unit 111a of the router 100 using RIPng determines whether or not the update timer value is included in the update message transmitted from the second router through the network.

That is, the message process unit 111a determines whether or not the “0xFE” is set for a metric field (m) of the update message transmitted from the second router. If the “0xFE” is set, the message processing unit 111a extracts the timer value set for the reserved field (k), and provides the extracted timer value to the timer setting unit 111b.

Meanwhile, the timer setting unit 111b enables the message processing unit 111a to generate the update message according to the random offset value and the update timer value set by administrator, and resets the timeout timer value according to the update timer value of the second router provided from the message processing unit 111a.

That is, the timer setting unit 111b compares the timeout timer value set by the administrator with the update timer value set for the second router, and resets the timeout timer value.

The timer setting unit 111b preferably compares the timeout timer value with the update timer value set for the second router with reference to the random offset value.

That is, it is preferable that the timer setting unit 111b compares a comparison value, which adds the maximum offset value to the update timer value of the second router provided from the message processing unit 111a, with the set timeout timer value.

For example, when the update timer value set for the router #2 102 is 40 seconds and the timeout timer value set for the router #1 101 is 40 seconds, the message generating unit 111c of the router #2 102 generates the update message in a period between 35 and 45 seconds according to the set update timer value and the random offset value, thereby transmitting the generated update message to the router #1 101.

At this time, if the routing protocol is RIP, the message generating unit 111c of the router #2 102 sets 0xFF for the AFI field (d) as shown in FIG. 4B, and sets the set update timer value, 40 seconds, for the next reserved field (e).

The message generating unit 111c sets numeric information in units of time as the set update timer value when setting the update timer value for the update message.

That is, the time unit of the timer value set according to the routing protocol is a unit of a second. Hence, if the set update timer value is 30 seconds, the message generating unit 111c sets 30 for a predetermined field of the update message.

Also, if the routing protocol is RIPng, the message generating unit 111c of the router #2 102 sets 0xFE indicating the update timer value for the metric field (m), and sets the update timer value of 40 seconds for the reserved field (k), as shown in FIG. 5B.

The message processing unit 111a of the router #1 101 extracts the update timer value, 40 seconds, from the update message transmitted from the router #2 102, and provides it to the timer setting unit 111b.

The timer setting unit 111b of the router #1 101 compares the update timer value, 40 seconds, of the router #2 102 provided by the message processing unit 111a, with the set timeout timer value, 40 seconds.

At this time, the timer setting unit 111b compares the comparison value, which adds the maximum offset value to the update timer value transmitted from the router #2 102, with the timeout timer value set for the router #1 101.

Specifically, the timer setting unit 111b compares the comparison value of 45 seconds, which adds 5 seconds of the maximum offset value to 40 seconds of the update timer value of the router #2 102 which is provided from message process unit 111a, with the timeout timer value set for the router #1 101.

As the result from the comparison, since the set timeout timer value is smaller than the update timer value of the router #2 102, the timer setting unit 111b resets the timeout timer value to 45 seconds.

At this time, resetting the timeout timer value by the timer setting unit 111b is to prevent flapping which can be generated at the router #1 101 due to a wrong timeout timer value.

That is, in order to prevent flapping, the timer setting unit 111b resets the timeout timer value of the router #1 101 to be equal to or greater by a predetermined value than the comparison value adding the maximum offset value to the update timer value of the router #2 102.

By contrast, if the first router 100 is initially driven, or the update message is received from the second router in the beginning, and if the update timer value of the second router is smaller than the set timeout timer value, the first router 100 can reduce the timeout timer value.

That is, when the update timer value of the router #3 103 is 30 seconds, if the routing protocol is RIP, the message generating unit 111c sets 0xFE for the AFI field (d), and sets the set update timer value, 30 seconds, for the next reserved field (e), as shown in FIG. 4B.

Also, if the routing protocol is RIPng, the message generating unit 111c of the router #3 103 sets 0xFE indicating the update timer value for the metric field (m), and sets the update timer value, 30 seconds, for the reserved field (k), as shown in FIG. 5B, thereby generating the message.

The message processing unit 111a of the router #1 101 extracts the update timer value of 30 seconds from the update message transmitted from the router #3 103, and provides the extracted update timer value to the timer setting unit 111b.

The timer setting unit 111b of the router #101 compares the update timer value, 30 seconds, of the router #3 103, which is provided from the message processing unit 111a, with the set timeout timer value, 40 seconds.

At this time, the timer setting unit 111b compares the comparison value, which adds the maximum offset value to the update timer value transmitted from the router #3 103, with the timeout timer value set for the router #1 101.

That is, the timer setting unit 111b compares the comparison value of 35 seconds, which adds 5 seconds of the maximum offset value to 30 seconds of the update timer value of the router #3 103 provided from the message process unit 111a, with the timeout timer value set for the router #1 101.

As the result of the comparison, since the set timeout timer value is greater than the update timer value of the router #3 103, the timer setting unit 111b resets the timeout timer value to 35 seconds.

The reason why the timer setting unit 111b resets the timeout timer value is to make the router #1 101 rapidly cope with rapid changes of the network.

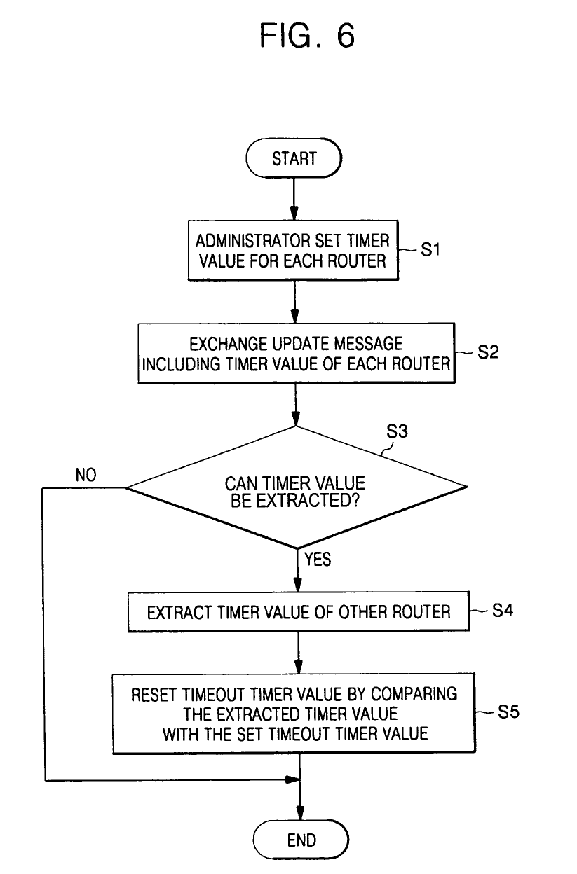

FIG. 6 is a flowchart of a method of setting each timer with a router according to an embodiment of the present invention.

Referring to FIG. 6, the administrator sets an update timer value, a timeout timer value and a garbage collection timer value for each router 100 (S1).

The message generating unit 111c of the first router 100 generates an update message according to a set update timer value and a random offset value, transmits the generated update message to the second router connected to the network, and receives the update message including the update timer value from the second router (S2).

As shown in FIGS. 4B or 5B, the message generating unit 111c generates the update message by setting both the update timer value and information indicating the update timer value.

According to one example, when RIP is used as a routing protocol of each router 100, the router #2 102 sets the update timer value of 40 seconds for the update message, and the router #3 103 sets the update timer value of 30 seconds for the update message.

That is, with regard to the update message generated in a period between 35 and 45 seconds according to the set update timer value of 40 seconds and the random offset value of ±0-5 seconds, the router #2 102 sets the update timer value of 40 seconds for the AFI field (d) and sets 0xFF indicating the update timer value for the reserved field (e). Then, the router #2 102 transmits the update message to the router #1 101.

Also, with regard to the update message generated in a period between 25 and 35 seconds according to the set update timer value of 30 seconds and the random offset value of ±0-5 seconds, the router #3 103 sets the update timer value of 30 seconds for the AFI field (d) and sets 0xFF indicating the update timer value for the reserved field (e). Then, the router #3 103 transmits the update message to the router #1 101.

By contrast, if RIPng is used as a routing protocol of each router 100, the router #2 102 sets the update timer value, 30 seconds, and 0xFE indicating the update timer value for the reserved field (j) and the metric field (m) respectively, which are composed of the update message generated in the period between 25 and 35 seconds, and thereby transmitting the update message to the router #1 101.

With regard to the update message generated in a period between 25 and 35 seconds according to the set update timer value of 30 seconds and the random offset value of ±0-5 seconds, the router #3 103 sets 30 seconds of the update timer value and 0xFF indicating the update timer value for the reserved field (j) and the metric field (m) respectively, and thereby transmitting the update message to the router #1 101.

The router #1 101 determines whether or not the update timer value included in the update message transmitted from other routers 102 and 103 connected to the network can be extracted (S3). If the update timer value can be extracted, the router #1 101 extracts the update timer value included in each update message transmitted from routers 102 and 103 (S4).

That is, when the router #1 101 has a function that the update timer value can be extracted from the update message by the administrator, i.e., has the timer process unit 111, the router #1 101 extracts the update timer value from the update message transmitted from routers 102 and 103.

When a function to reset the timer value for the routing processor 110 of the router #1 101 is not implemented, the routing processor 110 of the router #1 101 discards the update message. This is because an address family identifier field (d) of each update message which includes the update timer value and is transmitted from routers 102 and 103 is not valid.

If the update timer value is not included in each update message transmitted from routers 102 and 103, the routing processor 110 of the router #1 101 processes routing entry information included in the update message according to RIP or RIPng, and records routing information on the corresponding router in the routing table 112.

According to one example, if the routing protocol of each router 101, 102 and 103 is RIP, the message process unit 111a of the router #1 101 determines whether or not 0xFF indicating the update timer value of the update message transmitted from the router #2 102 or the router #3 103 is set for the AFI field (d). If 0xFF is set, the message processing unit 111a extracts the update timer value set for the next reserved field (e), and provides the extracted update timer value to the timer setting unit 111b.

By contrast, if the routing protocol of each router 101, 102 and 103 is RIPng, the message processing unit 111a of the router #1 101 determines whether or not 0xFE indicating the update timer value of the update message transmitted from the router #2 102 or the router #3 103 is set for the reserved field (j). If 0xFF is set, the message processing unit 111a extracts the update timer value set for the metric field (m) and provides the extracted update timer value to the timer setting unit 111b.

The timer setting unit 111b of the router #1 101 compares the timeout timer value of routers 102 and 103 provided from the message processing unit 111a with the timeout timer value set for the router #1 101, thereby resetting the timeout timer value (S5).

The timer setting unit 111b of the router #1 101 compares the comparison value adding the maximum offset value to the update timer value of each of the other routers 102 and 103 provided from the message processing unit 111a. If the timeout timer value is greater than the comparison value, then the timer setting unit 111b of the router #1 101 resets the timeout timer value to be equal to the comparison value.

That is, the message process unit 111a of the router #1 101 provides both the update timer value, 40 seconds, extracted from the update message transmitted from the router #2 102 and the update timer value, 30 seconds, extracted from the update message transmitted from the router #3 103 to the timer setting unit 111b.

The timer setting unit 111b compares the comparison value of 45 seconds which adds 5 seconds, the maximum offset vale, to 40 seconds, the update timer value, with the timeout timer value, 40 seconds, set for the router #1 101. As the result of the comparison, since the set timeout timer value is smaller than the comparison value, the timer setting unit 111b resets the timeout timer value to 45 seconds.

This is to prevent the router #2 102 from being determined to be invalid, because, when the router #2 102 transmits a former update message according to the set update timer value of 40 seconds and the maximum offset value of 5 seconds, and generates and transmits another update message after 45 seconds has elapsed, the router #1 101 fails to receive the update message from the router #2 102 within 40 seconds of the set timeout timer value.

In other words, this is to prevent flapping, which can occur when the router #1 101 determines the router #2 102 to be invalid, elects the best route of the third network 203 having an IP address of 10.10.10.0/24 as the router #3 103, stores routing information in the routing table 112, and records the router #2 102 as the next hop when the update message is transmitted from the router #2 102 in five seconds.

Also, when the router #1 101 is initially driven, or the update message is received from the second router, and the update timer value of the second router is smaller than the set timeout timer value, then the first router 100 can reduce the timeout timer value.

That is, the timer setting unit 111b of the router #1 101 compares the comparison value, 35 seconds, which adds the maximum offset vale, five seconds, to the update timer value, 30 seconds, of the router #3 103 provided from the message processing unit 111a, with the set timeout timer value, 40 seconds, thereby resetting the timeout timer value to 35 seconds, which is because the set timeout timer value is greater than the comparison value.

This allows the router #1 101 to actively cope with network changes by properly setting the timeout timer value set for the router #1 101 according to the update timer value transmitted by the router #3 103 as well as by making it possible for the router #1 101 to collect the update message transmitted from routers 102 and 103.

In other words, if the router #3 103 is not valid when the timeout timer value set for the router #1 101 is greater than the update timer value set for the router #3 103, then the router #1 101 times out the timer during the set timer value and then determines that the router #3 103 is not valid. Thus, in order to determine network changes, the router #1 101 has a standby time corresponding to the difference between the timeout timer value of the router #1 101 and the update timer value of the router #3 103.

Also, when the update timer value is included in the update message transmitted from each of the routers 102 and 103, the timer setting unit 111b of the router #1 101 is set to the maximum value of the timeout time values, which are reset according to the update timer value set for each of the routers 102 and 103.

Although an exemplary embodiment of the present invention has been described for illustrative purposes, those skilled in the art will appreciate that various modifications, additions and substitutions are possible, without departing from the scope and spirit of the invention as recited in the accompanying claims.

1. A router comprising:
a message extracting unit adapted to extract a timer value from an update message including the timer value transmitted from at least one other router over a network according to a routing protocol; and
a timer setting unit adapted to reset the timer value in response to a difference between the timer value extracted from the message extracting unit and a timer value preset in the router.

2. The router of claim 1, wherein the timer value comprises at least one of an update timer value, a timeout timer value, and a garbage collection timer value.

3. The router of claim 1, wherein the routing protocol comprises at least one of a Routing Information Protocol (RIP), and a Routing Information Protocol next Generation for Ipv6 (RIPng).

4. The router of claim 1, wherein the update message comprises at least one of information on the timer value set for the router and information indicating the timer value.

5. The router of claim 1, further comprising a message generating unit adapted to generate the update message using the set timer value and a random offset value based on a set routing protocol.

6. The router of claim 1, wherein the timer setting unit is adapted to reset the timer value of the router to a comparison value adding a maximum offset value to the timer value of another router, upon the comparison value being greater than the preset timer value.

7. The router of claim 1, wherein the timer setting unit is adapted to reset the timer value of the router to a comparison value adding the timer value transmitted from another router to a random offset value when the router is initially driven, upon the comparison value being smaller than the preset timer value.

8. The router of claim 1, wherein the timer setting unit is adapted to reset the timer value of the router to a comparison value adding the timer value transmitted from another router to a random offset value upon the router being connected to another router through the network, and upon the comparison value being smaller than the preset timer value.

9. A router comprising:
a message generating unit adapted to generate an update message including an update timer value set according to a routing protocol;
a message processing unit adapted to extract the update timer value including the update message transmitted from another router; and
a timer setting unit adapted to reset the timeout timer value of the router in response to a difference between the update timer value of the another router extracted from the message processing unit and the timeout timer value set for the router.

10. The router of claim 9, wherein the message generating unit is adapted to generate the update message using the set update timer value and a random offset value according to the set routing protocol.

11. The router of claim 9, wherein the timer setting unit is adapted to reset the timer value of the router to a comparison value adding a maximum offset value to the update timer value of the another router provided by the message processing unit, upon the comparison value being greater than the timeout timer value set for the router.

12. A method comprising:
receiving an update message at a router, the update message including a timer value from at least one other router according to a routing protocol;
extracting the timer value from the update message received from the at least one other router; and
resetting the timer value in response to a difference between the extracted timer value of the at least one other router and the set timer value.

13. The method of claim 12, wherein the update message is generated in response to the set timer value and a random offset value according to the routing protocol.

14. The method of claim 12, wherein resetting the timer value comprises:
comparing a comparison value adding a maximum offset value to the extracted timer value of the at least one other router with the timer value set for the router; and
resetting the timer value of the router to the comparison value upon the comparison value being greater than the timer value.

15. The method of claim 12, wherein the timer value of the router is reset to the comparison value when the router was initially driven upon a comparison value adding the timer value transmitted from the other router to a random offset value being smaller than the preset timer value.

16. The method of claim 12, wherein the timer value of the router is reset to the comparison value when the router was connected to one router through a network upon a comparison value adding the timer value transmitted from the at least one other router to a random offset value being smaller than the preset timer value.

17. The method of claim 12, wherein the timer value comprises at least one of an update timer value, a timeout timer value, and a garbage collection timer value.

18. The method of claim 12, wherein the update message comprises at least one of information of the timer value set for the router and information indicating the timer value.
